(19) United States
(12) Patent Application Publication
(10) Pub. No.: US 2019/0393008 A1
(43) Pub. Date: Dec. 26, 2019

(54) A PYROTECHNIC SHORT-CIRCUITER

(71) Applicant: ARIANEGROUP SAS, PARIS (FR)

(72) Inventors: Philippe LOPEZ, CASTELNAU (FR); Guillaume MARTY, AGONAC (FR); Ludovic LEGLIZE, BORDEAUX (FR); Romain LORENZON, EYSINES (FR)

(21) Appl. No.: 16/471,396

(22) PCT Filed: Dec. 14, 2017
(86) PCT No.: PCT/FR2017/053572

§ 371 Date: Jun. 19, 2019

(30) Foreign Application Priority Data
Dec. 20, 2016 (FR) 1662956

(51) Int. Cl. H01H 39/00; H02H 9/00

(52) U.S. Cl. CPC H01H 39/004; H02H 9/00

(57) ABSTRACT

A pyrotechnic short-circuiter has a body including a first chamber in communication with a pyrotechnic initiator; a second chamber having present therein a support in the form of a slide having present thereon two conductive parts, the support defining a housing, each conductive part having a deformable end portion, and a piston having a fitted conductive element, the pyrotechnic initiator being configured to cause the piston to pass from a first position in which the conductive element is disengaged from the end portions to a second position in which the conductive element is inserted in the housing and is in contact with each deformable end portion, the deformable end portions, in the second position, being deformed and exerting a holding force serving to block the conductive element in position in the housing.

### BACKGROUND OF THE INVENTION

The present invention relates to the general field of devices for closing an electrical circuit, or “short-circuiters”. The invention relates more particularly to a pyrotechnic short-circuiter, e.g. suitable for being triggered by firing a pyrotechnic charge present in a pyrotechnic initiator.

In known manner, in the event of an electrical installation failing, short-circuiters are used for short-circuiting a device or a portion of an electrical circuit that is to be protected so as to divert electricity quickly by means of the short-circuiter. This application applies to most onboard installations making use of an independent power source, such as a battery or storage battery, when such installations require rapid discharging under certain conditions in order to be made safe. By way of example, such devices are used in cars so as to dissipate electrical energy from certain portions of the electrical installation in an event of an accident.

Known pyrotechnic short-circuiters generally comprise a pyrotechnic initiator that serves, on being triggered, to connect two conductive parts together electrically by means of a conductor element. Nevertheless, those devices present drawbacks. In general, they do not enable contact pressure and contact area to be established between the conductor element and the conductive parts that are sufficient for safe use at high electrical powers. In addition, because of the speed and violence of their triggering, such devices are subject to the conductor element bouncing on the conductive parts. Such bounces can then generate electric arcs and can interrupt the circuit, thereby reducing reliability, safety, and the lifetime of the device and the circuit to which the device is connected.

There therefore exists a need for a pyrotechnic short-circuiter that does not present the above-mentioned drawbacks.

### OBJECT AND SUMMARY OF THE INVENTION

A main object of the present invention is thus to mitigate such drawbacks by proposing a pyrotechnic short-circuiter comprising a body having present therein:
a pressurizing first chamber in communication with an outlet of a pyrotechnic initiator;
a second chamber having present therein a support having present thereon two conductive parts that are separate from each other, the support defining a housing opening out into the second chamber between the two conductive parts, each conductive part having a deformable end portion extending in the second chamber and in register with the housing, the support having a slide structure engaged in an opening in an outside wall of the body; and
a piston separating the first and second chambers, the piston having a conductive element fitted thereto and configured to come into contact with the deformable end portions of the conductive parts;
the pyrotechnic initiator being configured to cause the piston to pass from a first position in which the conductive element is disengaged from the end portions to a second position in which the conductive element is inserted in the housing and is in contact with each deformable end portion, the deformable end portions, in the second position, being deformed and exerting a holding force serving to block the conductive element in position in the housing.

The first position may be a position in which no electricity can pass through the short-circuiter. In an embodiment, the short-circuiter may have only two conductive parts in the second chamber.

The short-circuiter of the invention is remarkable in that the conductive parts have deformable end portions that are suitable for exerting a holding force on the conductive element in order to hold it in the second position. Specifically, it is as a result of the deformation of the end portions that it becomes possible to hold and block the conductive element. The term “block” is used to mean that the conductive element can no longer move, and in particular can no longer return to the first position. The end portion is said to be “deformable”, meaning that it is suitable for deforming elastically or plastically when the piston and/or the conductive element come into contact therewith as a result of the pyrotechnic initiator being triggered. When the end portions deform elastically, the holding force that is exerted may be due to the elasticity of the deformable end portions. In addition, the holding force may be due to the dimensions of the housing and of the piston serving to “wedge” the conductive element by force in the housing.

This advantageous provision serves to prevent any bouncing of the conductive element on the conductive parts and it considerably reduces any risk of an electric arc forming and of the circuit being interrupted after triggering. The deformation of the deformable end portions also serve to damp the impact when the piston goes from the first position to the second position. The short-circuiter of the invention also makes it possible to increase contact pressure and contact area between the conductive element present on the piston and the end portions of the conductive parts, thereby enabling its use to be extended to fields where the electrical powers in question are high.

The fact that the conductive element is fitted to the piston makes a short-circuiter of the invention simpler to design and less expensive. The slide structure of the support enables the device to be assembled easily and provides better holding of the conductive parts in the device.

In an embodiment, the piston may have a face facing the conductive parts and from which there projects a portion in relief extending transversely relative to the conductive parts, the conductive element being fitted on said portion in relief.

In an embodiment, the portion in relief may present a section that is rectangular.

In an embodiment, the conductive element may present a section of U-shape.

In an embodiment, the conductive element may extend all along the portion in relief. In an embodiment, the conductive element may extend over at least half of the portion in relief.

In an embodiment, the deformable end portion of each conductive part may include one or more cuts. These cuts serve advantageously to make the deformable end portions easier to deform.

In an embodiment, the piston may include a skirt facing the housing, said skirt, when in the second position, co-operating with a portion in relief projecting from a bottom wall of the housing. The skirt may then present notches or slots that open out towards the second chamber and that serve to increase the flexibility of said skirt. Co-operation between the portion in relief and the skirt serves to improve holding of the conductive element in the housing, to provide the piston with guidance as it passes from the first position to the second position, and also to provide better impact damping.

In an embodiment, the portion relief projecting from the bottom wall of the housing may present a width that increases on going away from the second chamber. This advantageous provision serves to engage the skirt on the portion in relief like a Morse taper, thereby further improving holding of the conductive element in the second position and further improving impact damping.

In an embodiment, the conductive element may be present around said skirt.

In an embodiment, the conductive element, when in the first position, may face the second chamber.

The short-circuiter comprises a body in which there are present the first and second chambers, the support, and the piston, the body possibly being made of an electrically insulating material.

In an embodiment, the support may be made of an electrically insulating material. In an embodiment, the piston and the portion in relief on the piston may be made of an electrically insulating material.

In an embodiment, the end portion of each conductive part, when in the second position, may be clamped between an inside wall of the housing and the conductive element.

The invention also provides a protected electrical circuit comprising:
an electricity generator;
an electrical device connected to the electricity generator; and
a pyrotechnic short-circuiter as described above, a first conductive part of the short-circuiter being connected to a first terminal of the device and a second conductive part being connected to a ground of the electrical circuit. Under such circumstances, the first conductive part is different from the second conductive part.

The invention also provides an electrical installation including such a protected electrical circuit. Such an installation may be present in a motor vehicle.

### BRIEF DESCRIPTION OF THE DRAWINGS

Other characteristics and advantages of the present invention appear from the following description made with reference to the accompanying drawings, which show an embodiment having no limiting character. In the figures:

FIGS. 1A and 1B are exploded views of a short-circuiter in a first embodiment of the invention;

FIGS. 2A to 2C are section views of the short-circuiter of FIGS. 1A and 1B before, during, and after triggering;

FIGS. 3A and 3B are views of a short-circuiter in a second embodiment of the invention, before and after triggering;

FIGS. 4 and 5 are section views of short-circuiters in third and fourth embodiments of the invention;

FIG. 6 is a diagram of an example of an electrical installation including an electrical circuit protected by using a short-circuiter of the invention; and

FIGS. 7A-7B and 8A-8B show a short-circuiter in yet another embodiment of the invention.

### DETAILED DESCRIPTION OF THE INVENTION

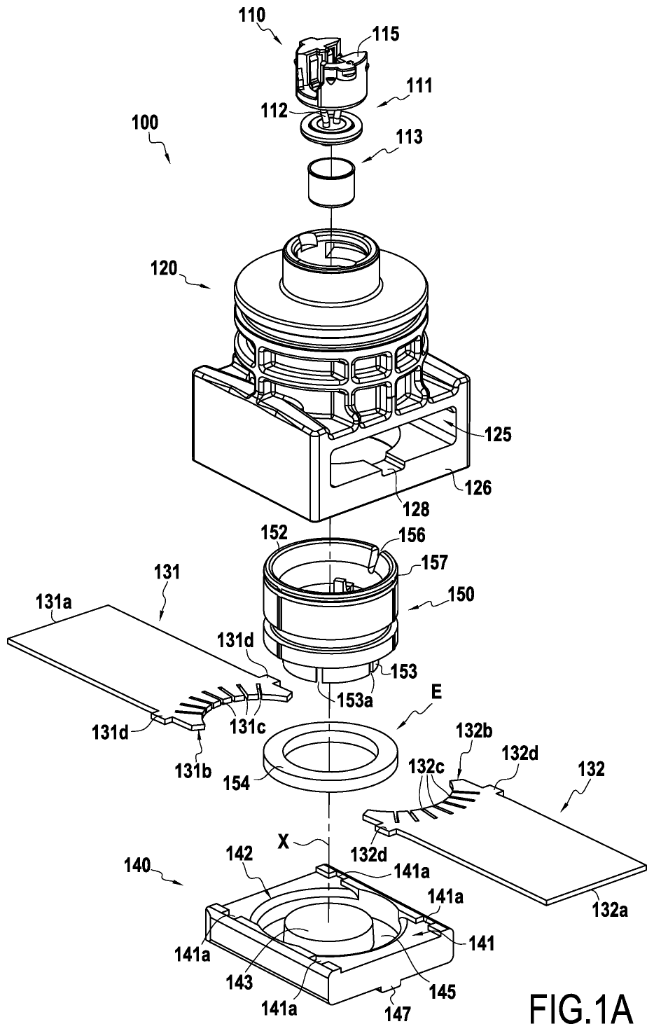

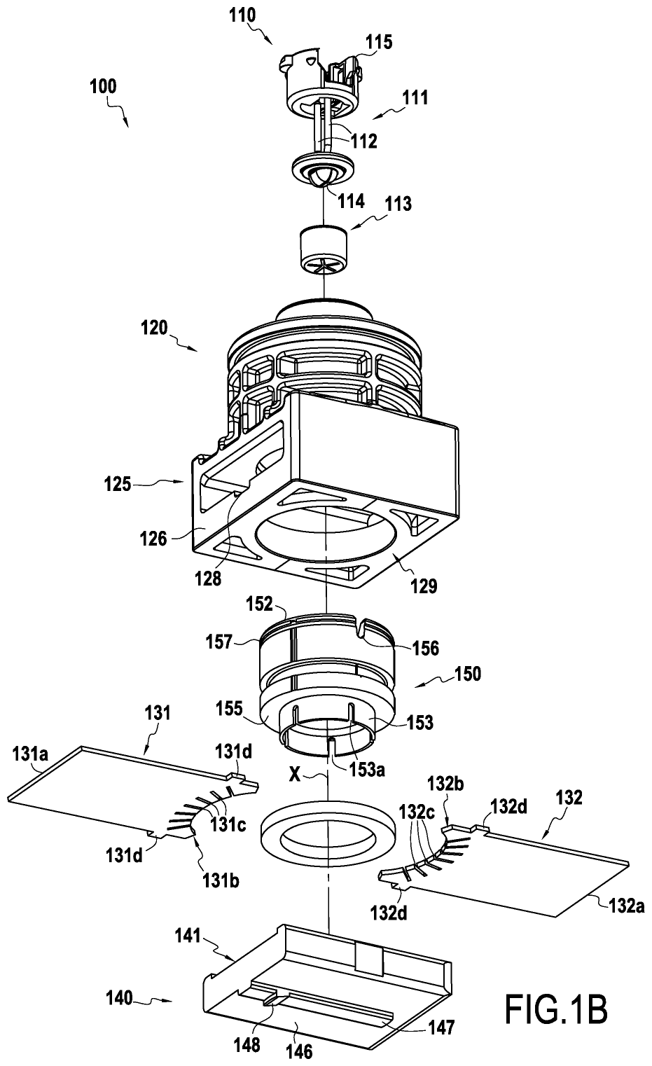

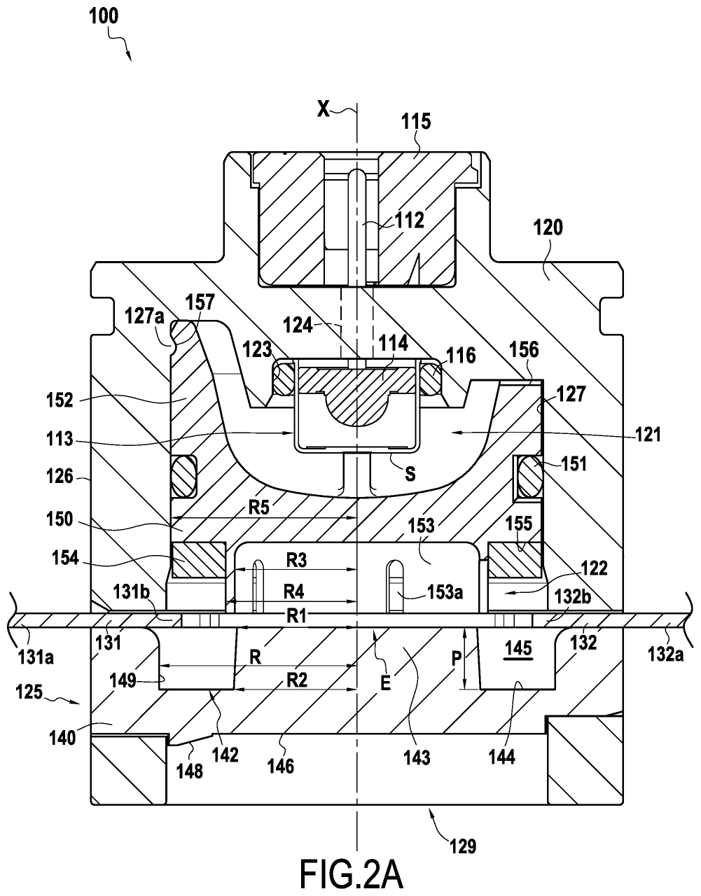

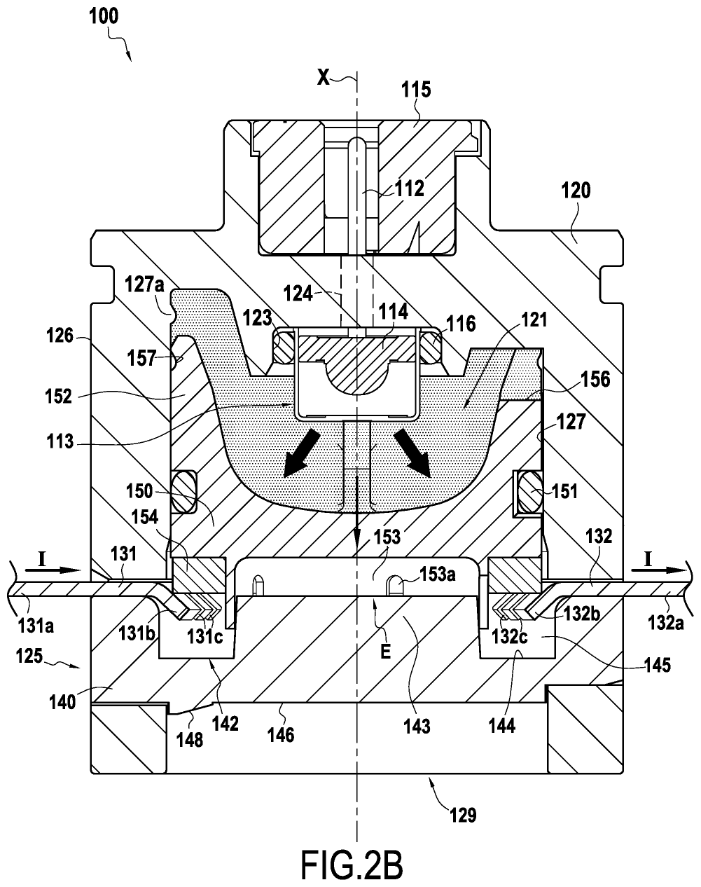

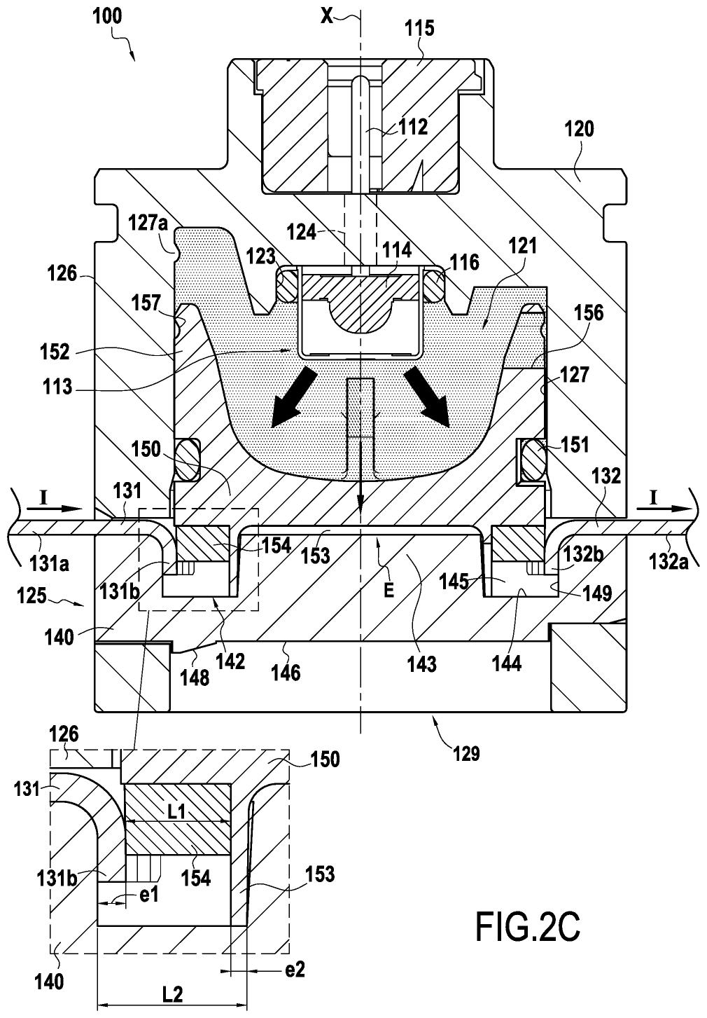

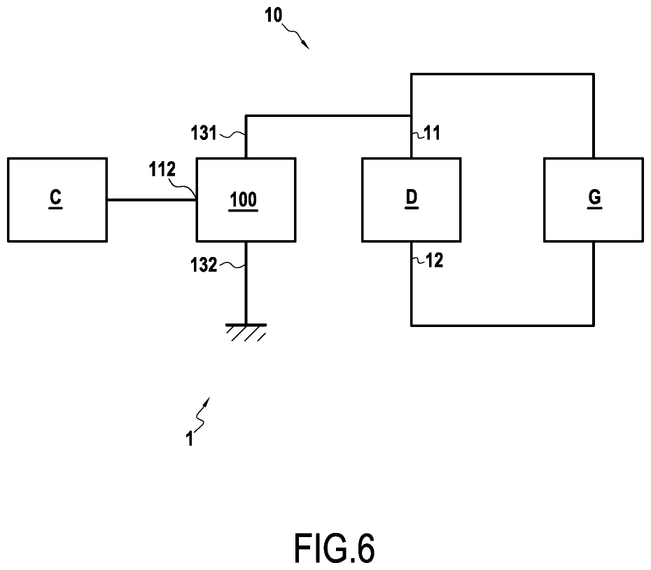

A short-circuiter 100 in a first embodiment of the invention is described with reference to FIGS. 1A to 2C. The short-circuiter 100 comprises a pyrotechnic initiator 110 having an igniter device 111 having two electrical conductors 112. The pyrotechnic initiator 110 also includes a pyrotechnic charge 113. The pyrotechnic charge 113 may be in the form of one or more single-piece blocks 114. The pyrotechnic initiator 110 also includes a retaining plug (or “retainer”) 115 providing an electrical and mechanical interface between the short-circuiter 100 and an electrical circuit 10 (see FIG. 6). In a variant, the charge 113 may be in granular form. Selecting the nature and the dimensions of the pyrotechnic charge for use in a particular application form part of the general knowledge of the person skilled in the art.

The short-circuiter 100 comprises a body 120 having present therein first and second chambers 121 and 122 (FIG. 2A). By way of example, the body 120 may be made of a thermoplastic or thermosetting material, and it may be electrically insulating. The pyrotechnic initiator 110 has a sealing gasket 116 made of elastically deformable material bearing against an inside wall 123 of the body 120. In the example shown, the igniter device 111 is housed in the body 120. The body 120 also presents two through channels 124, each of the conductors 112 extending in a distinct channel 124. The first chamber 121 constitutes a pressurizing chamber and it is in communication with an outlet S of the pyrotechnic initiator 110. The pyrotechnic initiator 110 is configured to pressurize the first chamber 121 when it is actuated. In the example shown, the pyrotechnic charge 113 is present in the first chamber 121. Nevertheless, it would not go beyond the ambit of the invention for the charge 113 to be present outside the first chamber 121, providing the first chamber remains in communication with an outlet S of the pyrotechnic initiator 110.

The body 120 also houses two electrically conductive parts 131 and 132 that are to be connected together electrically when the pyrotechnic initiator 110 is triggered. In the example shown, the conductive parts 131 and 132 may be in the form of flat tongues. Initially (i.e. before the short-circuiter is triggered), the two conductive parts 131 and 132 are disconnected from each other. Whatever the state of the short-circuiter 100, the conductive parts 131 and 132 are spaced apart from each other transversely (relative to an axis X specified below) by a distance that is not zero. Each conductive part 131 and 132 extends from a respective side of the short-circuiter 100 and they are for connecting via their ends 131a and 132a that are situated outside the short-circuiter 100 to an electrical circuit 10 (FIG. 6). Each of the conductive parts 131 and 132 presents a deformable end portion 131b, 132b that is present inside the second chamber 122. In this example, the conductive end portions 131b and 132b are in the shape of circular arcs, with the center of the circle being situated inside the second chamber 122 on the axis X. In the example shown, the deformable end portions 131b and 132b are provided with cuts 131c and 132c extending radially relative to the axis X and enabling said portions to be deformed more easily. Nevertheless, it would not go beyond the ambit of the invention for the cuts 131c and 132c not to be radial.

The conductive parts 131 and 132 are present on a support 140. In this example, the support 140 is made of electrically insulating material. By way of example, the support 140 may be made of a thermoplastic or thermosetting material. In the example shown, the support 140 is of slider or cassette structure for engaging in an opening 125 in the side wall 126 of the body 120 from the outside. In the example shown, the support 140 is present in the second chamber 122. The support 140 defines a guide 141 that receives and holds the conductive parts 131 and 132. The guide 141 also has notches 141a for co-operating with tongues 131d and 132d present on the sides of each conductive part 131 and 132 in order to block them in position in the guide 141. The support 140 also has a housing 142 arranged inside said support in the space E lying between the conductive parts 131 and 132. In the example shown in FIGS. 1A to 2C, the housing 142 is in the form of a blind circular housing that opens out into the second chamber 122 and that presents a radius R that is constant. The end portions 131b and 132b of the conductive parts 131 and 132 are present facing the housing 142.

In this example, a portion in relief 143 projects from the bottom wall 144 of the housing 142. The portion in relief 143 in this example extends from the bottom wall 144 over the entire depth P of the housing 142. The portion in relief 143 is in the form of a circular button or solid disk centered on the axis X. In the presently-shown example, at its end remote from the bottom wall 144 of the housing 142, the portion 143 in relief presents a first radius R1 that is less than the radius R2 presented by the portion in relief 143 at its base. The radii R1 and R2 are thus both strictly less than the radius R so as to leave an annular space around the portion in relief 143 forming a groove 145 in the housing, the end portions 131b and 132b extending over this annular space without extending over the portion in relief 143.

The support 140 is also provided with a guide rail 147 on a face 146 facing away from the second chamber 122. The guide rail 147 enables insertion of the support 140 into the body 120 to be guided by co-operating with one or more slots 128 provided in the body 120, particularly in the opening 125. Finally, a blocking portion in relief 148 is present on the rail 147 and serves to block the support 140 in position once it has been inserted in the body 120.

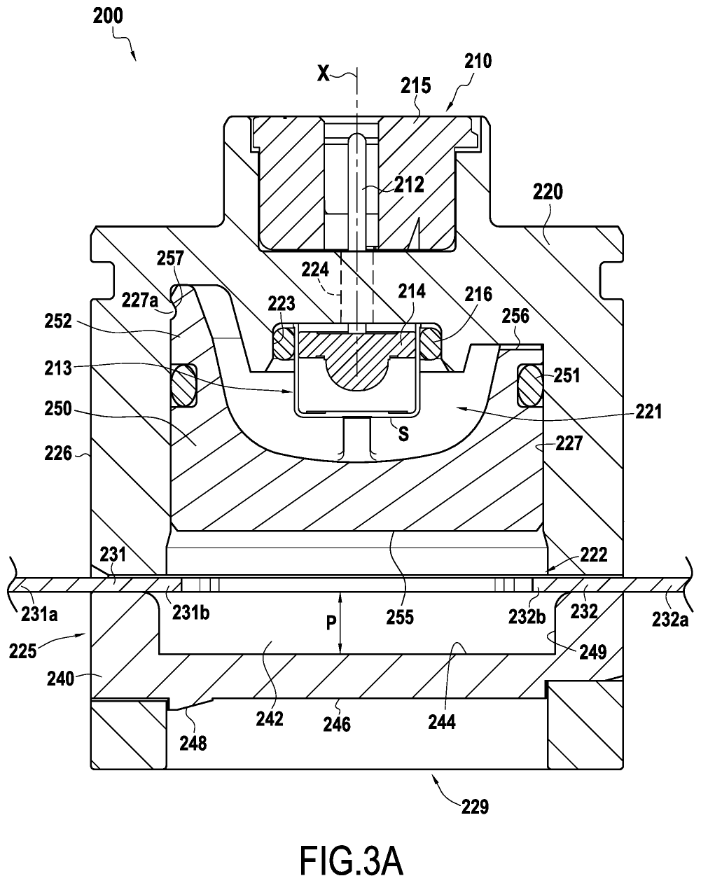

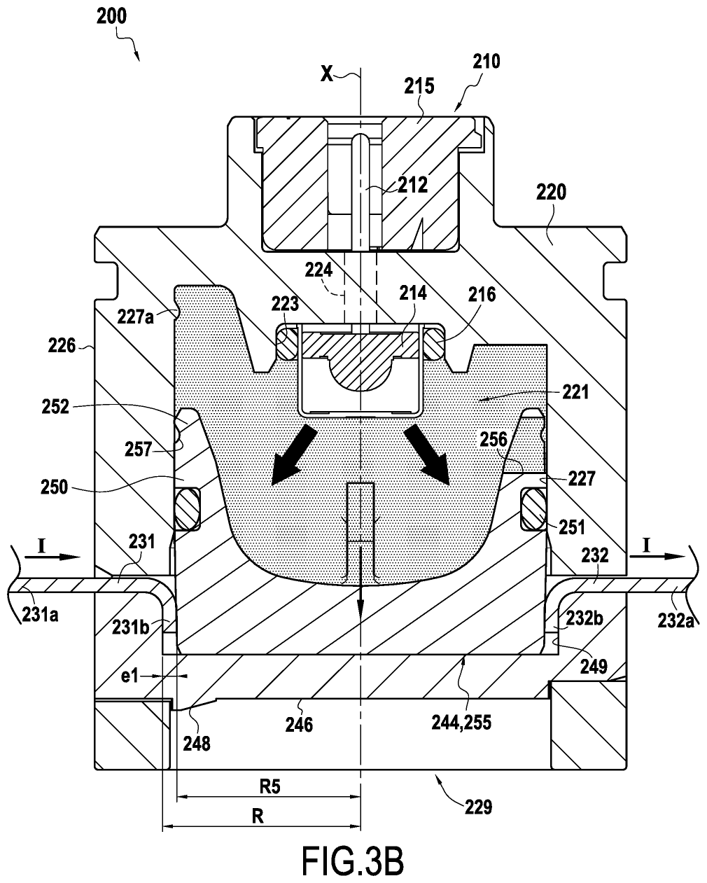

The short-circuiter 100 also has a piston 150 that is made in this example out of an electrically insulating material, e.g. polyetheretherketone (PEEK GF40) or polyphenylene sulfide (PPS) or polyamide (PA). In a variant that is described below (FIGS. 3A and 3B), the piston may be made of an electrically conductive material. The piston 150 separates the first chamber 121 in sealed manner from the second chamber 122. The piston 150 is situated between the first and second chambers 121 and 122. The piston 150 is configured to move in a cavity corresponding to the combination of the first and second chambers 121 and 122. The piston 150 has a sealing gasket 151 made of an elastically deformable material that bears against a side wall 127 inside the body. The side wall 127 surrounds the first and second chambers 121 and 122. The side wall 127 inside the body 120 defines an inside volume in which the first and second chambers 121 and 122 are present. In the example shown, the piston 150 presents a cylindrical shape centered on the axis X, which also corresponds to the axis along which the piston 150 moves inside the short-circuiter 100, and it is provided with a first skirt 152 extending towards the first chamber 121. This design for the piston 150 serves to obtain a short-circuiter 100 of compact shape.

In the example shown, the piston 150 also has a second skirt 153 that extends towards the second chamber 122. In this example, the second skirt 153 is provided with a plurality of slots or notches 153a that open out into the second chamber 122 going towards the housing 142. These notches 153a impart a degree of flexibility to the skirt 153, enabling it to deform more easily. In this example, the skirt 153 presents an inside radius R3 that lies between the radii R1 and R2 of the portion in relief 143. As a result, the skirt 153 is suitable for co-operating with the portion in relief 143 in the housing 142 and can be engaged on said portion in relief 143 like a Morse taper. In this example, the skirt 153 also presents an outside radius R4 that is strictly less than the radius R5 of the piston 150 so as to leave an annular space between the second skirt 153 and the inside wall 127 of the body 120.

The piston 150 is also provided with an electrically conductive element 154 that may be fastened to the piston 150. By way of example, the electrically conductive element 154 may be made of copper. In the example shown, the electrically conductive element 154 is in the form of a washer centered on the axis X. In the configuration shown in FIG. 2A (i.e. before the short-circuiter 100 is triggered), the conductive element 154 is housed in one direction between the second skirt 153 and the inside wall 127 of the body, and in another direction between the end portions 131b, 132b of the conductive parts 131 and 132 and a face 155 of the piston 150 that faces the second chamber 122. When the pyrotechnic initiator 110 is triggered, the function of the conductive element 154 is to connect the conductive parts 131 and 132 together electrically.

In an embodiment that is not shown, the second skirt 153 need not present an outside radius R4 that is constant, and for example it could be conical in shape with its smallest outside radius being situated beside the second chamber 122. The conductive element 154 could also be split, e.g. so as to be in the form of a split washer. As a result, during assembly of the short-circuiter 100, the conductive element 154 may be engaged on the skirt 153 by deforming circumferentially. This provision serves to further increase the contact pressure between the conductive element 154 and the end portions of the conductive parts 131 and 132 after the short-circuiter 100 has been triggered.

There follows a description of an example of assembling together the various elements of the short-circuiter 100 shown in FIGS. 1A to 2C.

Initially, the pyrotechnic initiator is fitted to the body 120 by inserting the pyrotechnic charge 113 through the bottom 129 of the body 120 and inserting the retaining plug 115 in an end of the body 120 that is remote from the bottom 129. Thereafter, the piston 150 is inserted by force through the bottom 129 of the body 120. The piston 150 presents a positioning portion in relief 156, e.g. in the form of an axial notch for cooperating with a portion in relief present on the inside wall 127 of the body 120. This co-operation serves to prevent the piston 150 from turning and thus avoids it turning about the axis X when the first chamber 121 is pressurized by the pyrotechnic initiator 110. The piston 150 also presents a circumferential notch 157 in its first skirt 152 for the purpose of co-operating with a bead 127a present on the inside wall 127 of the body so as to block the piston in the first position while the short-circuiter 100 is in storage and in transport. It should be observed that the notch 157 and the bead 127a are dimensioned so that the piston 150 can be released after the initiator 110 has been triggered. The support 140 on which the conductive parts 131 and 132 have been placed is then inserted through the opening 125 in the side wall 126 of the body 120 transversely relative to the travel axis X. The resulting short-circuiter 100 is ready to be connected to an electrical circuit 10 (FIG. 6), e.g. by soldering the ends 131a and 132a of the conductive parts 131 and 132 to said circuit.

With reference to FIGS. 2A to 2C, there follows a description of how the above-described first embodiment of the short-circuiter 100 of the invention operates.

In FIG. 2A, the short-circuiter 100 has not yet been triggered and it is in a first configuration, e.g. for storage. In this configuration, the piston 150 is in a first or “high” position. The conductive parts 131 and 132 are not electrically connected together by the conductive element 154, which is then separate therefrom, and no electricity can flow between the conductive parts 131 and 132. Thereafter, the pyrotechnic initiator 110 is activated or triggered, e.g. in response to an electrical pulse issued by a control device C (FIG. 6) of the electrical circuit to which the conductors 112 are connected. The effect of triggering the pyrotechnic initiator 110 is to cause the short-circuiter 100 to change to a second configuration in which the piston 152 is in a second or “low” position.

More precisely, actuating the pyrotechnic initiator 110 serves to cause one or more pyrotechnic charges 113 to enter into combustion so as to generate combustion gas that pressurizes the first chamber 121 (solid arrows in FIGS. 2B and 2C). Pressurizing the first chamber 121 in this way causes the piston 150 to move towards the conductive parts 131 and 132. In the example shown, the piston 150 is configured to move without deforming when the short-circuiter 100 goes from the first configuration (FIG. 2A) to the second configuration (FIG. 2C). The piston 150 is driven to move in translation along the axis X towards the conductive parts 131 and 132 on passing from the first configuration to the second configuration. In particular, because of the presence of the positioning portion in relief 159, the movement of the piston 150 on passing from its first position to its second position does not include any component in rotation about the axis X.

In FIG. 2B, there can be seen an intermediate position where the piston 150 is no longer in the first position but is not yet in the second position. It can be seen that the piston 150 has begun to move down under the effect of the increasing pressure in the first chamber 121. The conductive element 154 carried by the piston 150 comes into contact with the deformable end portions 131b and 132b of the conductive parts 131 and 132 and begins to deform them. In this example, deformation of the end portions 131b and 132b consists in folding them towards the bottom wall 144 of the housing 142. The cuts 131c and 132c in the end portions 131b and 132b serve to facilitate this deformation. Simultaneously, electrical contact is established between the conductive element 154 and the conductive parts 131 and 132, so an electric current I can flow between them. Still simultaneously, the second skirt 153 of the piston 150 comes progressively into contact with the portion in relief 143 present in the housing 142. In other words, the portion in relief 143 becomes received progressively in the skirt 153 of the piston 150. The portion in relief 143 and the second skirt 153 thus serve to guide the piston 150 and to damp its movement.

In FIG. 2C, the piston 150 has reached its second or “final” position. In this position, electrical contact between the two conductive parts 131 and 132 has been established in permanent manner. The electrical contact between each conductive part 131, 132 and the conductive element 154 takes place in the second position along the direction determined by the axis X. The deformable end portions 131b and 132b are now folded towards the bottom wall 144 of the housing, perpendicularly to the direction in which the conductive parts 131 and 132 extend. The second skirt 153 of the piston 150 is received in the groove 145 of the housing 144. The end portions 131b and 132b are thus clamped or gripped vice-like between an inside wall 149 of the housing 142 and the conductive element 154. In this position, the deformed end portions 131b and 132b exert a holding force on the piston 150 (and on the conductive element 154), thereby blocking it in this second position. The progressive deformation of the end portions serves to absorb a portion of the kinetic energy of the piston and to eliminate any risk of bounce. Furthermore, because of the force exerted by the end portions 131b and 132b, the second skirt 153 is engaged on the portion in relief 143 like a Morse taper, thereby blocking the piston 150 even more securely in the second position.

Given the above-described description of the operation of the short-circuiter 100, it can be understood that the radius R of the housing 142 needs to be adapted to receive the piston 150, and more precisely its second skirt 153, the conductive element 154, and the deformed end portions 131b and 132b, while enabling the piston 150 and the conductive element 154 to be held effectively in the second position. For example, the width L2 (FIG. 2C) of the groove 145 (measured at the level of the bottom wall 144) in the housing 142 should be substantially equal to or very slightly greater than the sum of the thickness e1 of a conductive part 131 or 132, plus the width L1 of the conductive element 154 measured perpendicularly to the axis X plus the thickness e2 of the second skirt 153. The same applies to defining the length over which each end portion 131b, 132b extends into the second chamber 122, which needs to be determined as a function of the depth P (FIG. 2A) of the housing 142 so that the end portions 131b and 132b can be contained therein once they have been folded. It should also be observed that the end portions 131b and 132b should not extend into the second chamber 122 beyond the second skirt 153 of the piston 150, for obvious reasons.

With reference to FIGS. 3A and 3B, there follows a description of a short-circuiter 200 in a second embodiment of the invention. Unless mentioned to the contrary, reference signs that correspond between the various embodiments designate characteristics that are identical.

As above, the short-circuiter 200 is shown in FIG. 3A in a first configuration before being triggered. In contrast to the short-circuiter 100, the piston 250 does not have a second skirt, and it is generally cylindrical in shape over its entire extent along the axis X. In this embodiment, the housing 242 in the support 240 does not have a portion in relief and it presents a bottom wall 244 that is plane. Still in this embodiment, the conductive element is made integrally with the piston 250. In other words, the piston 250 is made entirely out of an electrically conductive material and in this example it performs the function of the conductive element. Even if not clearly visible in the figures, the end portions 231b and 232b may include cuts as in the short-circuiter 100 in order to make them easier to deform.

When the pyrotechnic initiator is triggered in order to cause the piston 250 to go from the first position (FIG. 3A) to the second position (FIG. 3B), the piston 250 becomes inserted in the housing 242, thereby having the effect of deforming (specifically folding) the end portions 231b and 232b of the conductive parts 231 and 232, which then exert a holding force so as to block the piston 250 in this second position. The end portions 231b and 232b are thus clamped or held vice-like between an inside wall 249 of the housing 242 and the conductive piston 250. Electrical contact is established between each end portion 231b, 232b and the conductive piston 250 so as to allow electricity to flow between the conductive parts 231 and 232.

In the light of the above-described operation of the short-circuiter 200, it can be understood that the radius R (FIG. 3B) of the housing 242 should be adapted to receive the piston 250 and the deformed end portions 231b and 232b, while enabling the piston 250 to be held effectively in the second position. For example, the radius R of the housing 242 needs to be substantially equal to or slightly greater than the sum of the radius R5 of the piston plus the thickness e1 of a conductive part 231, 232. The same applies for defining the length over which each end portion 231b, 232b extends into the second chamber 222, which length must be determined as a function of the depth P of the housing so that the end portions 231b and 232b can be contained therein once folded.

It should be observed that the characteristics that differ between the above-described embodiments may be combined while remaining within the ambit of the present invention.

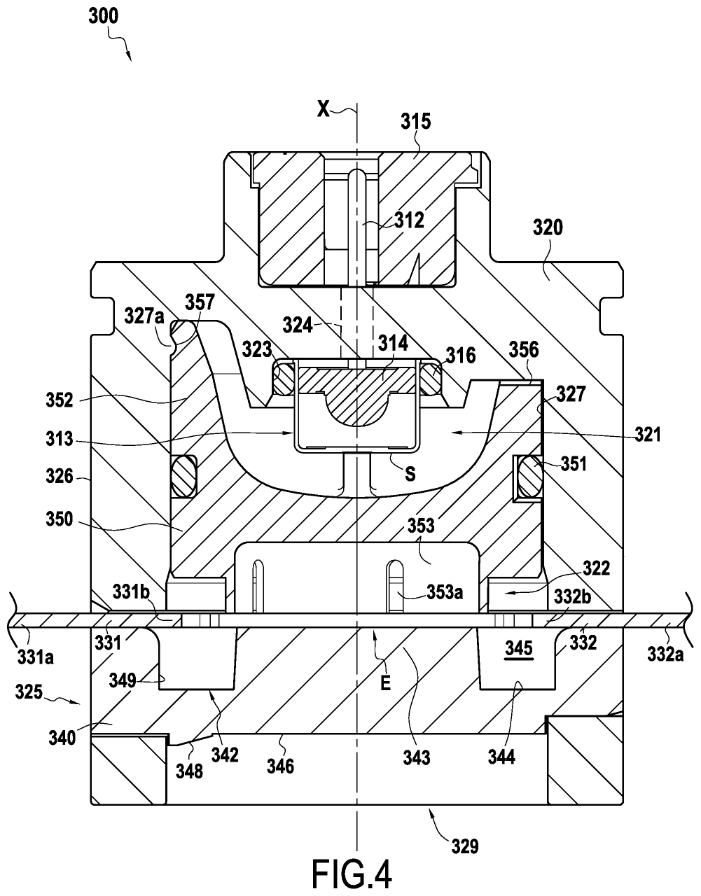

In particular, FIG. 4 shows a short-circuiter 300 in a third embodiment of the invention that reproduces the characteristics of the short-circuiters 100 and 200. The operation of the short-circuiter 300 is identical to that of the above-described short-circuiters 100 and 200, and corresponding reference signs in the figures refer to characteristics that are identical. The short-circuiter 300 is shown while the piston 350 is in its first position. Like the short-circuiter 100, the piston 350 has a skirt 353 that can be engaged on a portion in relief 343 projecting from the bottom wall 344 of the housing 342. In addition, the short-circuiter 300 has a piston 350 that is formed integrally with the conductive element, like the piston 250 of the short-circuiter 200. In other words, in this example, the piston 350 is entirely electrically conductive.

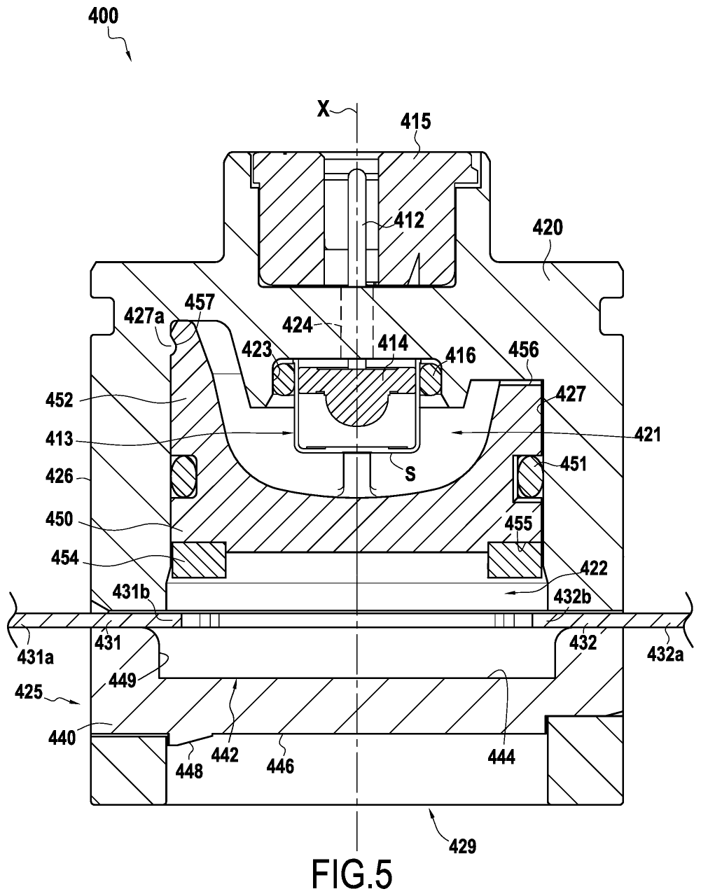

FIG. 5 shows a short-circuiter 400 in a fourth embodiment of the invention. The operation of the short-circuiter 400 is identical to that of the above-described short-circuiters 100, 200, and 300, and corresponding reference signs in the figures refer to characteristics that are identical. In this example, the short-circuiter 400 is shown when the piston 450 is in its first position. The short-circuiter 400 has a piston 450 made of electrically insulating material, and in this example it does not have a second skirt. In a manner similar to the short-circuiter 300, in this embodiment, the housing 442 does not present a portion in relief on its bottom wall 444. The piston 450 also has a conductive element 454 that is fitted thereto, in this example in the form of a washer fastened to the face 455 of the piston 450 that faces the second chamber 422.

FIG. 6 is a diagram showing an example installation 1 comprising an electrical circuit 10 that is protected by using a pyrotechnic short-circuiter 100 of the invention. The circuit 10 comprises an electricity generator G, an electrical device D (the electrical device may be some other electrical circuit) powered by the electricity generator G, and a pyrotechnic short-circuiter 100 of the invention. The first conductive part 131 of the pyrotechnic short-circuiter 100 is connected to a first terminal 11 of the device, and its second conductive part 132 is connected to a ground of the electrical circuit. The installation 1 may also have a control device C for controlling the short-circuiter 100 and configured to trigger the short-circuiter in response to a variation in a predefined parameter. The control device C may be connected to the conductors 112 of the pyrotechnic initiator 110. For example, the control device C may activate the short-circuiter in the event of detecting that the current in the circuit has exceeded a threshold, in the event of a temperature threshold being exceeded in the device D, in the event of an impact, etc. Thus, when the short-circuiter 100 is triggered, the electricity that was previously flowing through the device D is diverted to ground.

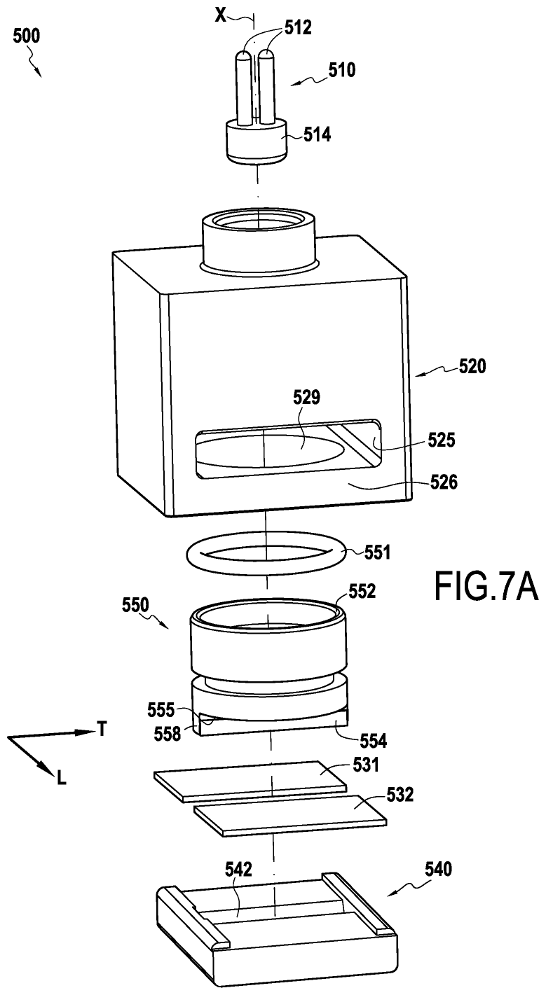

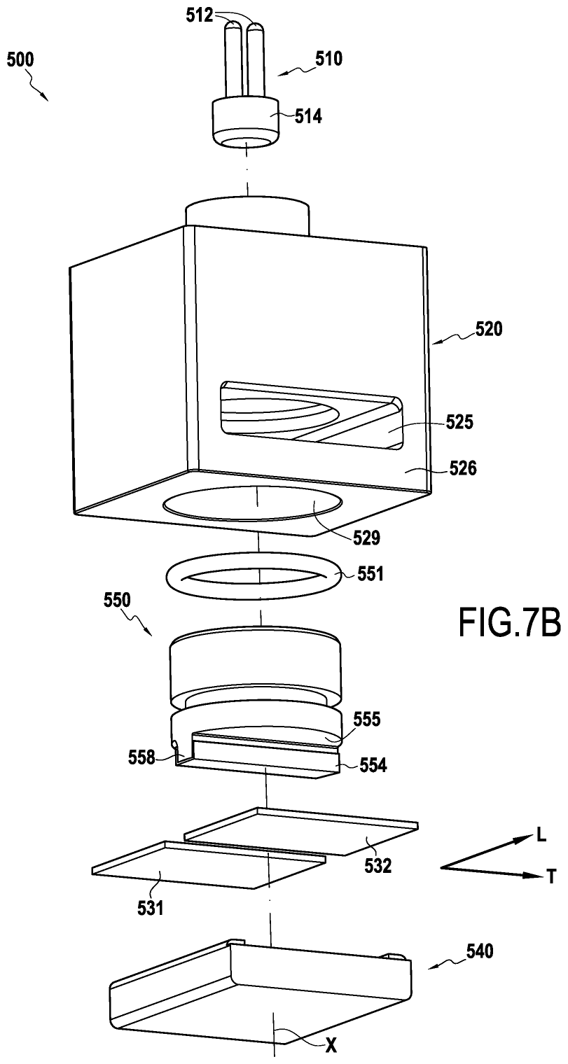

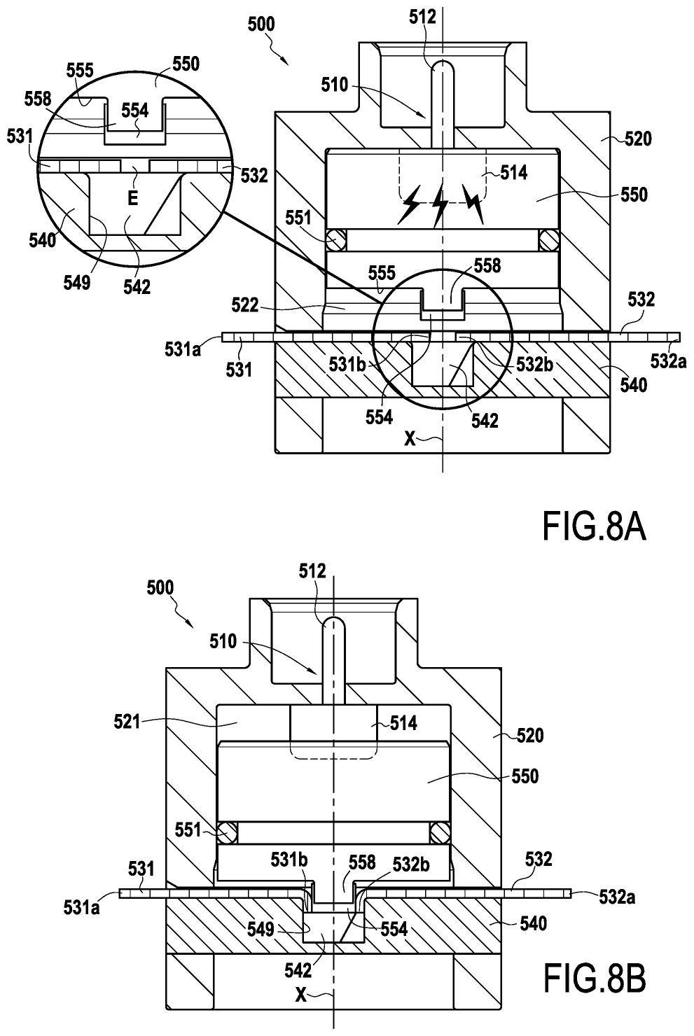

FIGS. 7A and 7B show a short-circuiter 500 in yet another embodiment of the invention shown in an exploded perspective view, and FIGS. 8A and 8B show it in section respectively when the piston is in the first position and when it is in the second position. The operation of the short-circuiter 500 is identical to that of the above-described short-circuiters 100, 200, 300, and 400, and corresponding reference signs in the figures designate characteristics that are identical. In this embodiment, on its face 555 facing the conductive parts 531 and 532, the piston 550 has a projecting portion in relief 558 that, in this example, extends in the transverse direction T, i.e. transversely relative to the conductive parts 531 and 532 (i.e. in a direction that is transverse to the axis L in which the conductive parts extend in this example). The portion in relief 558 presents a section that is generally rectangular in a longitudinal plane (i.e. containing the axis L and the vertical axis X). The portion in relief 558 extends facing the housing 542 present in the support 540. In this example, the portion in relief 558 extends in register with the space E between the conductive parts 531 and 532. The support 540 is in the form of a slide engaged in an opening 525 in the side wall 526 of the body 520. In the example shown, a conductive element 554 presenting a U-shaped longitudinal section is fitted on the portion in relief 558, e.g. is adhesively bonded to the portion to the relief 558. By way of example, the conductive element 554 may be obtained by folding a conductive plate so as to give it its shape. In this example, the conductive element 554 extends over the entire length of the portion in relief 558 on the piston 550 measured along the transverse direction T. The conductive element 554 could extend over at least half of this length. In this manner, when the piston 550 passes from the first position (FIG. 8A, no electricity can flow through the short-circuiter) to the second position (FIG. 8B, electricity can flow through the short-circuiter), the portion in relief 558 moves to occupy the space E between the conductive parts 531 and 532, and the conductive element 554 connects the conductive parts 531 and 532 together electrically while deforming their deformable end portions 531b and 532b, thereby likewise having the effect of blocking the piston 550 in the second position. In the second position, the conductive element 554 and the portion in relief 558 on the piston 550 are thus wedged between the deformable end portions 531b and 532b of the conductive parts 531 and 532. The dimensions of the portion in relief 558 and of the conductive element 554 should in particular be adapted as a function of the sizes of the housing 542 and of the space E between the conductive parts 531 and 532.

This embodiment presents the advantage of being simple and inexpensive to make, in particular because the conductive element is a fitting. The shape of the conductive element (of U-shaped section) further increases the simplicity of manufacturing the short-circuiter.

1. A pyrotechnic short-circuiter comprising a body having present therein:
a pressurizing first chamber in communication with an outlet of a pyrotechnic initiator;
a second chamber having present therein a support having present thereon two conductive parts that are separate from each other, the support defining a housing opening out into the second chamber between the two conductive parts, each conductive part having a deformable end portion extending in the second chamber and in register with the housing, the support having a slide structure engaged in an opening in an outside wall of the body; and
a piston separating the first and second chambers, the piston having a conductive element fitted thereto and configured to come into contact with the deformable end portions of the conductive parts;
the pyrotechnic initiator being configured to cause the piston to pass from a first position in which the conductive element is disengaged from the end portions to a second position in which the conductive element is inserted in the housing and is in contact with each deformable end portion, the deformable end portions, in the second position, being deformed and exerting a holding force serving to block the conductive element in position in the housing.

2. A short-circuiter according to claim 1, wherein the piston has a face facing the conductive parts and from which there projects a portion in relief extending transversely relative to the conductive parts, the conductive element being fitted on said portion in relief.

3. A short-circuiter according to claim 2, wherein the conductive element presents a section of U-shape.

4. A short-circuiter according to claim 1, wherein the deformable end portion of each conductive part includes one or more cuts.

5. A short-circuiter according to claim 1, wherein the piston includes a skirt facing the housing, said skirt, when in the second position, co-operating with a portion in relief projecting from a bottom wall of the housing.

6. A short-circuiter according to claim 5, wherein the portion relief projecting from the bottom wall of the housing presents a width that increases on going away from the second chamber.

7. A short-circuiter according to claim 5, wherein the conductive element is present around said skirt.

8. A short-circuiter according to claim 1, wherein the conductive element, when in the first position, faces the second chamber.

9. A short-circuiter according to claim 1, wherein the end portion of each conductive part, when in the second position, is clamped between an inside wall of the housing and the conductive element.

10. A protected electrical circuit comprising:
an electricity generator;
an electrical device connected to the electricity generator; and
a pyrotechnic short-circuiter according to claim 1, a first conductive part of the short-circuiter being connected to a first terminal of the device and a second conductive part being connected to a ground of the electrical circuit.

11. An installation including a protected electrical circuit according to claim 10.
